(19) United States
(12) Patent Application Publication
(10) Pub. No.: US 2019/0044397 A1
(43) Pub. Date: Feb. 7, 2019

(54) STATOR FOR ROTARY ELECTRIC MACHINE

(71) Applicant: HIWIN MIKROSYSTEM CORP., Taichung City (TW)

(72) Inventors: Tzer-Wei LAI, Taichung City (TW); Kun-Mao HE, Taichung City (TW); Li-Wei CHENG, Taichung City (TW)

(21) Appl. No.: 15/669,902

(22) Filed: Aug. 5, 2017

(51) Int. Cl. H02K 1/14; H02K 3/18

(52) U.S. Cl. CPC H02K 1/148; H02K 3/18

(57) ABSTRACT

A stator for the rotary electric machine including an outer yoke, an inner yoke and a plurality of coils is provided. The inner yoke is coaxially held within the outer yoke, and includes a plurality of teeth and a plurality of slots. The teeth are extending from the center of the stator radially and alternately. The slots are configured between the neighboring teeth. The coils are wound on the teeth respectively to provide a gap between the neighboring coils wherein the gap comprises a gap area equal to or less than 20% of a slot area. Therefore, the stator for the rotary electric machine provides higher torque and the motor efficiency by increasing the coil area factor.

### BACKGROUND OF THE INVENTION

### Field of the Invention

The invention relates to an electric machine, and more particularly to a stator for the rotary electric machine.

### Description of the Related Art

The torque of the motor is directly proportional to the coil turns whereby the more coil turns provide the higher torque. In addition, the copper loss can be decreased by enlarging the diameter of the coil. Accordingly, the coil space factor is raised by increasing the coil turn and the diameter of the coil to enhance the motor efficiency.

With respect to the conventional technology for raising the coil space factor, the US patent US2013300247 disclosed a coil configuration thereby alternating the neighboring coils to raise the coil space factor and the torque of the motor.

Although the abovementioned patent can raise the coil space factor, the stator is divided into multiple T-type segments such that the stator is provided by assembling the segments after winding the coils on the segments respectively. Accordingly, both the alternative coil configuration and the roundness of the stator are difficult to control.

### SUMMARY OF THE INVENTION

In view of the disadvantages of prior art, the object of the present invention is to provide a stator for the rotary electric machine to increase the coil area factor and enhance the stator assembly.

To achieve the above object, the present invention provides a stator for the rotary electric machine including an outer yoke, an inner yoke and a plurality of coils. The inner yoke is coaxially held within the outer yoke, and includes a plurality of teeth and a plurality of slots. The teeth are extending from the center of the stator radially and alternately. The slots are configured between the neighboring teeth. The coils are wound on the teeth respectively to provide a gap between the neighboring coils wherein the gap comprises a gap area equal to or less than 20% of a slot area.

In one embodiment of the present invention, the neighboring coils include the same turns.

In one embodiment of the present invention, the outer yoke includes a ring portion and a plurality of indentations configured on the ring portion and corresponding to the inner yoke.

In one embodiment of the present invention, the teeth are disposed against the indentations respectively wherein each of the indentations is complementary to an end portion of each of the teeth.

In one embodiment of the present invention, the gap area is more than 9% of the slot area.

In one embodiment of the present invention, the inner yoke and the outer yoke are configured by stacking a plurality of silicon steel sheets.

In one embodiment of the present invention, the coil within each of the slots comprises a coil area equal to or more than 70% of the slot area.

### BRIEF DESCRIPTION OF THE DRAWINGS

FIG. 1 is a schematic view of the stator without the coil according to the embodiment of the present invention;

FIG. 2 is an exploded view of the stator without the coil according to the embodiment of the present invention;

FIG. 3 is a side view of the stator according to the embodiment of the present invention;

FIG. 4A is a schematic view illustrating the gap s and the winding space within each of the slot;

FIG. 4B is an enlarged view of the portion B according to FIG. 4A;

FIG. 5 is a relative diagram illustrating the area of the coil and the turns;

FIG. 6 is an enlarged view of the portion A according to FIG. 3; and

FIG. 7 is a relative diagram illustrating the rated torque and coil-less factor according to the embodiment of the present invention.

### DETAILED DESCRIPTION OF THE PREFERRED EMBODIMENTS

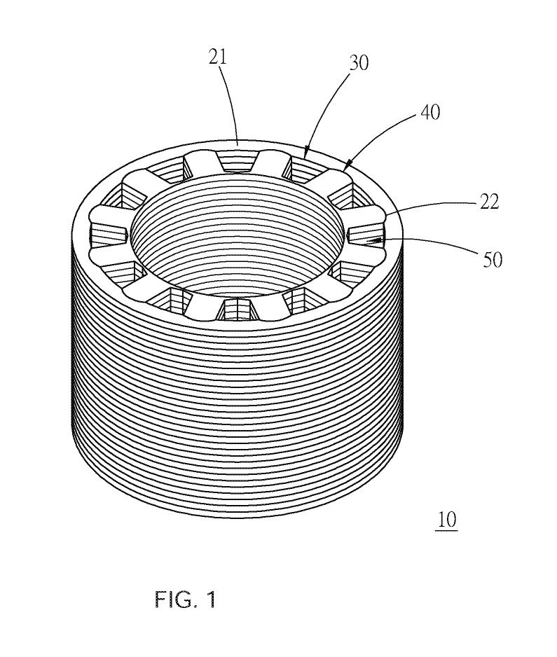

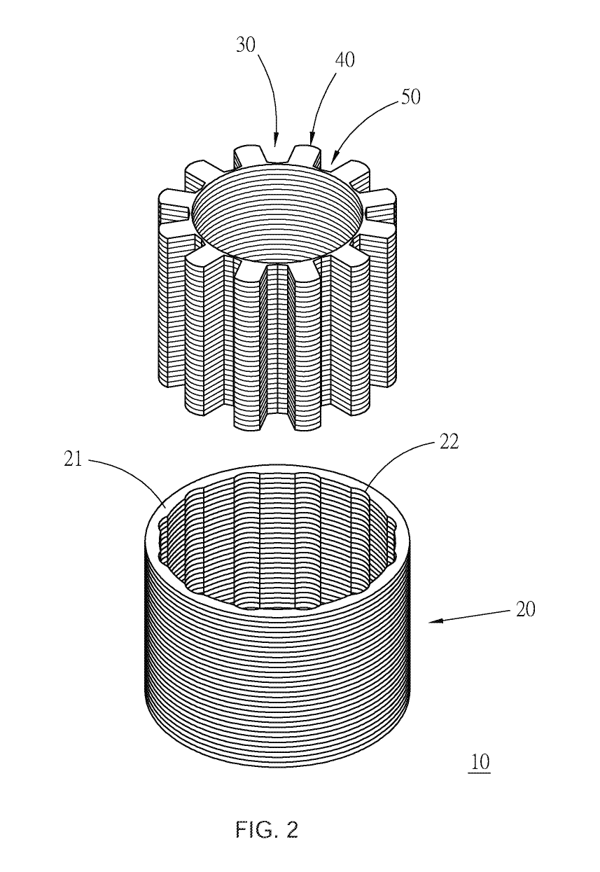

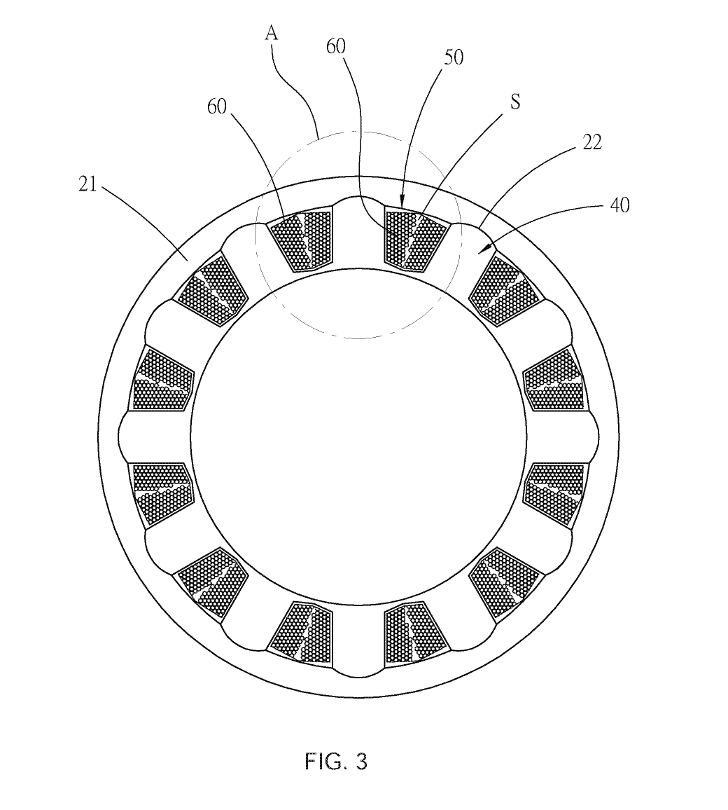

Refer to FIG. 1 to FIG. 3. The stator 10 for the rotary electric machine includes an outer yoke 20, an inner yoke 30 and a plurality of coils 60 wherein the inner yoke 30 is coaxially held within the outer yoke 20, and the coils 60 are disposed on the inner yoke 30.

The outer yoke 20 is configured by stacking a plurality of silicon steel sheets, and includes a ring portion 21 and a plurality of indentations 22 configured on the ring portion 21 and corresponding to the inner yoke 30.

The inner yoke 30 is configured by stacking a plurality of silicon steel sheets, and includes a plurality of teeth 40 and a plurality of slots 50 wherein the teeth 40 are extending from the center of the stator radially and alternately, and the slots 50 are configured between the neighboring teeth 40.

The coils 60 are wound on the teeth 40 respectively to be contained within the slots 50 wherein the neighboring coils 60 comprise the same turns. Besides, there is a gap s between the neighboring coils 60 within the same slot 50 to prevent from contacting with each other.

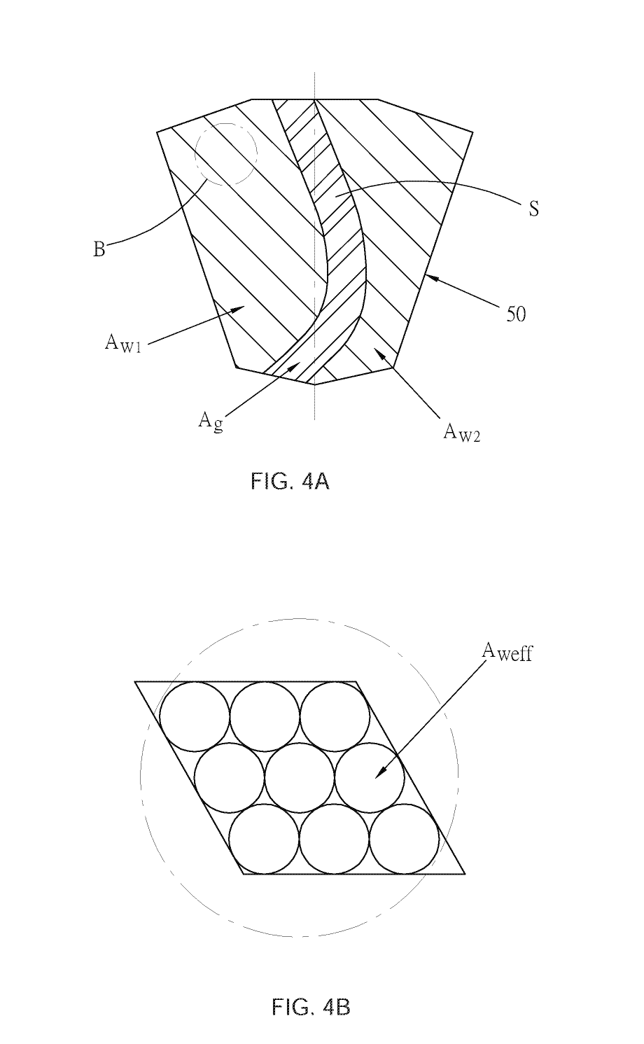

Refer to FIG. 4A and FIG. 4B. FIG. 4A illustrates the area ratio between the gap s and the winding space within each of the slot 50, and FIG. 4B illustrates the portion B according to FIG. 4A, wherein

the area of each of the slot 50 is defined as As;

the area of the gap s is defined as Ag;

the winding space in the left of the gap s is defined as Aw1;

the winding space in the right of the gap s is defined as Aw2;

the winding space within each of the slot 50 is defined as Aw (Aw1+Aw2); and

the area of the coil is defined as Aweff.

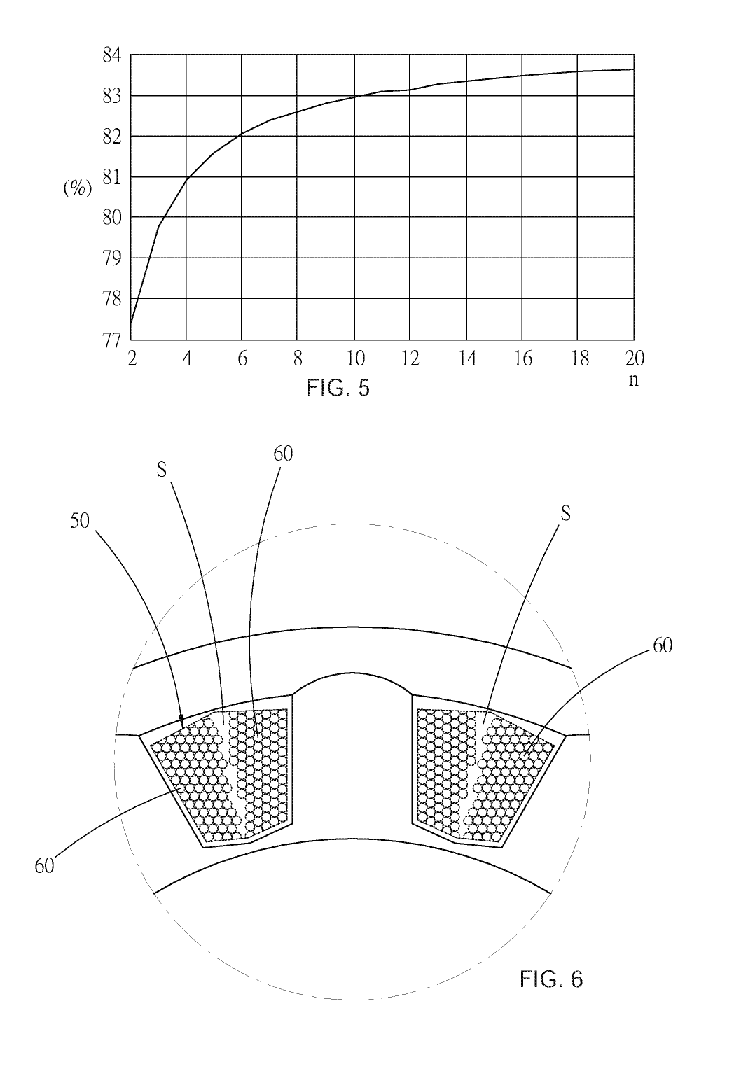

Accordingly, the relative diagram between the area of the coil (Aweff/Aw) and the turns (n) is shown as FIG. 5.

Refer to FIG. 6 showing partial portion in the radial direction of the inner yoke 30. The area of the gap s within each of the slot 50 is between 9% and 20% of the slot area. The area of the coil within each of the slot 50 is equal to or more than 70% of the slot area.

Specifically, Aweff is 0.85*Aw in 400 turns embodiment. When the coil area factor is more than 70%, the area of the gap s, between 9% and 20% of the slot area, can be derived from the following formulas:

Aweff/As>0.7

0.85Aw>0.7As

Aw/As>14/17

Ag/As>3/17

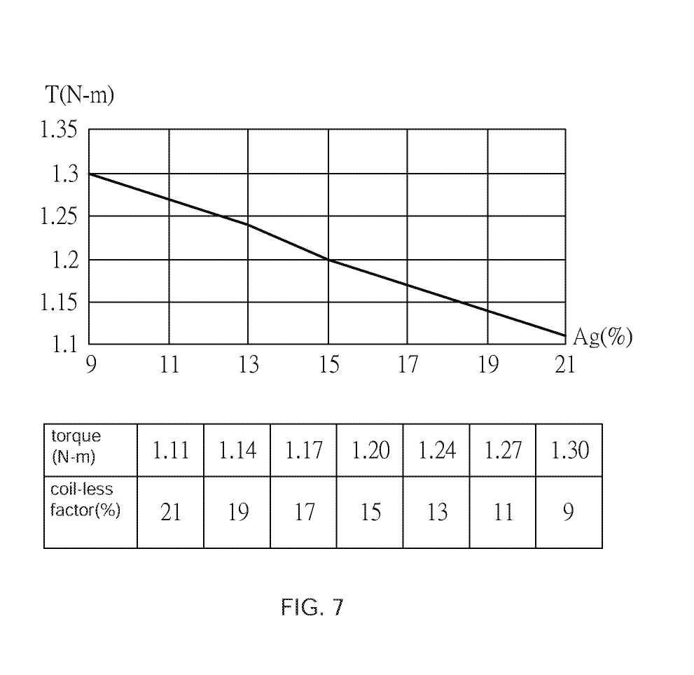

Refer to FIG. 7. The stator 10 for the rotary electric machine provides higher torque and the motor efficiency by increasing the coil area factor. Moreover, the two section stator of the outer yoke 20 and the inner yoke 30 facilitates the coils winding to enhance the quality. Besides, each of the indentations 22 is complementary to an end portion of each of the teeth 40 to assist the assembly and provide firm connection.

What is claimed is:

1. A stator for the rotary electric machine, comprising:
an outer yoke;
an inner yoke, coaxially held within the outer yoke, and comprising a plurality of teeth and a plurality of slots wherein the teeth are extending from the center of the stator radially and alternately, and the slots are configured between the neighboring teeth; and
a plurality of coils, wound on the teeth respectively to provide a gap between the neighboring coils wherein the gap comprises a gap area equal to or less than 20% of a slot area.

2. The stator for the rotary electric machine as claimed in claim 1, wherein the neighboring coils comprise the same turns.

3. The stator for the rotary electric machine as claimed in claim 1, wherein the outer yoke comprises a ring portion and a plurality of indentations configured on the ring portion and corresponding to the inner yoke.

4. The stator for the rotary electric machine as claimed in claim 3, wherein the teeth are disposed against the indentations respectively.

5. The stator for the rotary electric machine as claimed in claim 4, wherein each of the indentations is complementary to an end portion of each of the teeth.

6. The stator for the rotary electric machine as claimed in claim 1, wherein the gap area is more than 9% of the slot area.

7. The stator for the rotary electric machine as claimed in claim 1, wherein the inner yoke is configured by stacking a plurality of silicon steel sheets.

8. The stator for the rotary electric machine as claimed in claim 1, wherein the outer yoke is configured by stacking a plurality of silicon steel sheets.

9. The stator for the rotary electric machine as claimed in claim 1, wherein the coil within each of the slots comprises a coil area equal to or more than 70% of the slot area.
